(19) United States
(12) Patent Application Publication
(10) Pub. No.: US 2016/0323499 A1
(43) Pub. Date: Nov. 3, 2016

(54) METHOD AND APPARATUS FOR FORMING IMAGES AND ELECTRONIC EQUIPMENT

(71) Applicant: Sony Corporation, Tokyo (JP)

(72) Inventors: Na WEI, Beijing (CN); Dahai LIU, Beijing (CN); Hui LI, Beijing (CN)

(21) Appl. No.: 14/892,788

(22) PCT Filed: Aug. 17, 2015
(86) PCT No.: PCT/IB2015/056254

§ 371 Date: Mar. 16, 2016

(30) Foreign Application Priority Data
Dec. 19, 2014 (CN) 201410798877.X

(51) Int. Cl. H04N 5/232; H04N 5/374

(52) U.S. Cl. CPC H04N 5/23212; H04N 5/374

(57) ABSTRACT

Embodiments of the present disclosure provide an image forming method and apparatus and electronic device. The image forming method includes: acquiring sound information emitted by an object and/or image information of the object; determining a position of the object according to the acquired sound information and/or image information; adjusting a focusing point or a focusing zone based on the position of the object; using the adjusted focusing point or focusing zone for focusing; and shooting to obtain an image. With the embodiments of the present disclosure, automatic focusing may be performed accurately and an effect of highlighting specific object and using its clear image may be obtained, thereby forming an image of higher quality.

### CROSS REFERENCE TO RELATED APPLICATION AND PRIORITY CLAIM

Priority is claimed from Chinese Patent Application No. 201410798877.X, filed Dec. 19, 2014, the entire disclosure of which is incorporated by this reference.

### TECHNICAL FIELD

The present disclosure relates to an image processing technology, and in particular to an image forming method and apparatus and an electronic device.

### BACKGROUND

As the popularity of portable electronic devices (such as a digital single lens reflex camera, a smart mobile phone, a tablet personal computer, and a portable digital camera, etc.), shooting an image or a video becomes more and more easy. There usually exists a camera in a portable electronic device, which may shoot an object by means of automatic focusing, etc.

Currently, in the process of focusing of the camera, a principle of imaging by reflecting light from an object may be used, in which the reflected light is received by a sensor, such as a charge coupled device (CCD) sensor, or a complementary metal oxide semiconductor (CMOS) sensor, in the electronic device, and an electrically-powered focusing apparatus is driven after processing by a software program.

The electronic device may have one or more focusing points, and a user may select one from them; or a focusing zone consisting of multiple focusing points may be provided, and the electronic device may use a focusing point or the focusing zone for automatic focusing, thereby obtaining a clear image.

It should be noted that the above description of the background art is merely provided for clear and complete explanation of the present disclosure and for easy understanding by those skilled in the art. And it should not be understood that the above technical solution is known to those skilled in the art as it is described in the background art of the present disclosure.

### SUMMARY

However, it was found by the inventors that in some cases, an ideal image is hard to be obtained due to inaccurate focusing. For example, in shooting an object in groups of people in a scenic spot, images of faces of other people than the object are not desired or expected to be highlighted. If an existing automatic focusing mode is used for shooting, it is possible that the focusing point or the focusing zone cannot be centralized on the object, and the object cannot be accurately focused, hence an image of higher quality cannot be obtained.

Embodiments of the present disclosure provide an image forming method and apparatus and an electronic device, in which the object can be accurately focused, hence an image of higher quality can be obtained.

According to a first aspect of the embodiments of the present disclosure, there is provided an image forming method, including:

acquiring sound information emitted by an object and/or image information of the object;

determining a position of the object according to the acquired sound information and/or image information;

adjusting a focusing point or a focusing zone based on the position of the object;

using the adjusted focusing point or focusing zone for focusing; and

shooting to obtain an image.

According to a second aspect of the embodiments of the present disclosure, before shooting to obtain an image, the method further includes:

matching the acquired sound information with a pre-stored registered sound; and

determining the position of the object according to the acquired sound information if the matching is successful.

According to a third aspect of the embodiments of the present disclosure, the sound information includes a sound content and/or a sound characteristic; and the sound matching is determined as being successful when the sound content and/or the sound characteristic in the acquired sound information is/are in consistence with a sound content and/or a sound characteristic in the registered sound.

According to a fourth aspect of the embodiments of the present disclosure, before shooting to obtain an image, the method further includes:

matching the acquired image information with a pre-stored registered image; and

determining the position of the object according to the acquired image information if the matching is successful.

According to a fifth aspect of the embodiments of the present disclosure, the image information includes person information and/or scene information, and the registered image includes person information and/or scene information.

According to a sixth aspect of the embodiments of the present disclosure, the person information includes one of the following information or a combination thereof: a face of a person, a body gesture, and a hand gesture identity; and the scene information includes one of the following information or a combination thereof: a designated object, a building, a natural scene, and an artificial ornament.

According to a seventh aspect of the embodiments of the present disclosure, the adjusting a focusing point or a focusing zone based on the position of the object includes:

selecting one or more focusing points to which the position of the object corresponds from multiple focusing points based on the position of the object, or selecting a part of the focusing zone to which the position of the object corresponds from the whole focusing zone based on the position of the object.

According to an eighth aspect of the embodiments of the present disclosure, the image forming method further includes:

recording a sound of the object so as to obtain the registered sound, or obtaining via a communication interface the registered sound transmitted by another device.

According to a ninth aspect of the embodiments of the present disclosure, the image forming method further includes:

performing information prompt for matching success when the acquired sound information is matched with the registered sound, and/or performing information prompt for matching failure when the acquired sound information is not matched with the registered sound.

According to a tenth aspect of the embodiments of the present disclosure, the image forming method further includes:

shooting the object so as to obtain the registered image, or obtaining via a communication interface the registered image transmitted by another device.

According to an eleventh aspect of the embodiments of the present disclosure, the image forming method further includes:

performing information prompt for matching success when the acquired image information is matched with the registered image, and/or performing information prompt for matching failure when the acquired image information is not matched with the registered image.

According to a twelfth aspect of the embodiments of the present disclosure, there is provided an image forming apparatus, including:

an information acquiring unit, configured to acquire sound information emitted by an object and/or image information of the object;

a position determining unit, configured to determine a position of the object according to the acquired sound information and/or image information;

an adjusting unit, configured to adjust a focusing point or a focusing zone based on the position of the object;

a focusing unit, configured to use the adjusted focusing point or focusing zone for focusing; and

a shooting unit, configured to shoot to obtain an image.

According to a thirteenth aspect of the embodiments of the present disclosure, the image forming apparatus further includes:

a sound matching unit, configured to match the acquired sound information with a pre-stored registered sound;

and the position determining unit is further configured to determine the position of the object according to the acquired sound information if the matching is successful.

According to a fourteenth aspect of the embodiments of the present disclosure, the image forming apparatus further includes:

an image matching unit, configured to match the acquired image information with a pre-stored registered image;

and the position determining unit is further configured to determine the position of the object according to the acquired image information if the matching is successful.

According to a fifteenth aspect of the embodiments of the present disclosure, the adjusting unit selects one or more focusing points to which the position of the object corresponds from multiple focusing points based on the position of the object, or selects a part of the focusing zone to which the position of the object corresponds from the whole focusing zone based on the position of the object.

According to a sixteenth aspect of the embodiments of the present disclosure, the image forming apparatus further includes:

a sound registering unit, configured to record a sound of the object so as to obtain the registered sound, or obtain via a communication interface the registered sound transmitted by another device.

According to a seventeenth aspect of the embodiments of the present disclosure, the image forming apparatus further includes:

a sound information prompting unit, configured to perform information prompt for matching success when the acquired sound information is matched with the registered sound, and/or perform information prompt for matching failure when the acquired sound information is not matched with the registered sound.

According to an eighteenth aspect of the embodiments of the present disclosure, the image forming apparatus further includes:

an image registering unit, configured to shoot the object so as to obtain the registered image, or obtain via a communication interface the registered image transmitted by another device.

According to a nineteenth aspect of the embodiments of the present disclosure, the image forming apparatus further includes:

an image information prompting unit, configured to perform information prompt for matching success when the acquired image information is matched with the registered image, and/or perform information prompt for matching failure when the acquired image information is not matched with the registered image.

According to a twentieth aspect of the embodiments of the present disclosure, there is provided an electronic device, having an image forming element and a focusing apparatus and including: the image forming apparatus as described above.

An advantage of the embodiments of the present disclosure exists in that the position of the object is determined according to the acquired sound information and/or image information, and a focusing point or a focusing zone is adjusted based on the position of the object. Therefore, focusing may be performed accurately and an effect of highlighting the object may be obtained, thereby forming an image of higher quality.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated in size, e.g., made larger in relation to other parts than in an exemplary device actually made according to the disclosure. Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. The same element is represented with the same reference number throughout the drawings.

In the drawings:

FIG. 1 is a flowchart of the image forming method of Embodiment 1 of the present disclosure;

FIG. 2 is a schematic diagram of performing automatic focusing by using the prior art;

FIG. 3 is a schematic diagram of a focusing point of the electronic device of an embodiment of the present disclosure;

FIG. 4 is a schematic diagram of a viewfinder in forming an image of Embodiment 1 of the present disclosure;

FIG. 5 is another schematic diagram of a viewfinder in forming an image of Embodiment 1 of the present disclosure;

FIG. 6 is another flowchart of the image forming method of Embodiment 1 of the present disclosure;

FIG. 7 is a further flowchart of the image forming method of Embodiment 1 of the present disclosure;

FIG. 8 is a schematic diagram of the structure of the image forming apparatus of Embodiment 2 of the present disclosure;

FIG. 9 is another schematic diagram of the structure of the image forming apparatus of Embodiment 2 of the present disclosure;

FIG. 10 is a further schematic diagram of the structure of the image forming apparatus of Embodiment 2 of the present disclosure; and

FIG. 11 is a schematic diagram of the systematic structure of the electronic device of Embodiment 3 of the present disclosure.

### DETAILED DESCRIPTION

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the disclosure are described primarily in the context of a portable electronic device in the form of a mobile telephone (also referred to as “mobile phone”). However, it shall be appreciated that the disclosure is not limited to the context of a mobile telephone and may relate to any type of appropriate electronic apparatus, and examples of such an electronic device include a digital single lens reflex camera, a media player, a portable gaming device, a PDA, a computer, and a tablet personal computer, etc.

An image forming element (such as an optical element of a camera) has a range of depths of field. In a process of focusing, the image forming element may form an object plane (a camber similar to a spherical surface) of a clear image on a photosensitive plane (i.e. a plane where a sensor, such as a CCD or a CMOS, is present), thereby forming a range of depths of field. A clear image of an object in the range of depths of field may be formed in the image forming element. The range of depths of field (or the object plane) may be moved driven by an electrically-powered focusing apparatus, such as being moved from a near end (a wide angle end) to a distal end (a telephoto end), and combined focusing of the object is formed after one or more times of reciprocal movement, such that the focusing point is centralized on the object, thereby completing the focusing and obtaining a clear image.

### Embodiment 1

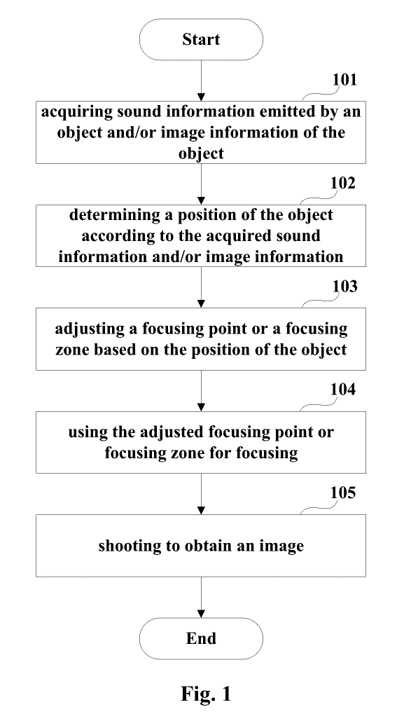

An embodiment of the present disclosure provides an image forming method. FIG. 1 is a flowchart of the image forming method of the embodiment of the present disclosure. As shown in FIG. 1, the image forming method includes:

Step 101: acquiring sound information emitted by an object and/or image information of the object;

Step 102: determining a position of the object according to the acquired sound information and/or image information;

Step 103: adjusting a focusing point or a focusing zone based on the position of the object;

Step 104: using the adjusted focusing point or focusing zone for focusing; and

Step 105: shooting to obtain an image.

In this embodiment, the image forming method may be carried out by an electronic device having an image forming element, the image forming element being integrated in the electronic device, for example, the image forming element may be a front camera of a smart mobile phone. The electronic device may be a mobile terminal, such as a smart mobile phone or a digital camera; however, the present disclosure in not limited thereto. The image forming element may be a camera, or a part of the camera; and also, the image forming element may be a lens (such as a single lens reflex camera lens), or a part of the lens; however, the present disclosure in not limited thereto.

Furthermore, the image forming element may be detachably integrated with the electronic device via an interface; and the image forming element may be connected to the electronic device in a wired or wireless manner, such as being controlled by the electronic device via wireless WiFi, Bluetooth, or near field communication (NFC). However, the present disclosure in not limited thereto, and other manners of connecting the electronic device and the image forming element and controlling the image forming element by the electronic device may also be used.

In this embodiment, the position of the object may refer to a position of the object relative to the electronic device; for example, the object is located at the left or right of the electronic device, etc. The position of the object relative to the electronic device may be embodied by a position of the object at a real-time view-finding liquid crystal screen. For example, the real-time view-finding liquid crystal screen of the electronic device may have 1024×768 pixels, and a real-time image to which the object corresponds may be located at 20×10 pixels at the left of the liquid crystal screen.

In this embodiment, the position of the object (such as whether the object is located at left front or right front of the electronic device) may be determined according to a sound of the object (such as “cheese” emitted by the object) or an acquired image of the object (such as the face of the object in the real-time view-finding liquid crystal screen).

Then a focusing point or a focusing zone of the electronic device is adjusted according to the position of the object. For example, in a case where the object is located at the left front of the electronic device, one or more left focusing points are selected from multiple focusing points. Afterwards, the selected focusing point is used for focusing. The focusing may be performed by a focusing apparatus; for example, the movement of the range of the depths of field of the image forming element may be controlled, such as moving the near to the distant, or moving reciprocally between the near end and the distal end.

The focusing apparatus may include: a voice coil motor (VCM), including but not limited to a smart VCM, a conventional VCM, VCM2, VCM3; a T-lens; a piezo motor drive, a smooth impact drive mechanism (SIDM); and a liquid actuator, etc., or other forms of focusing motors.

Therefore, focusing may be performed accurately and an effect of highlighting the object may be obtained, thereby forming an image of higher quality.

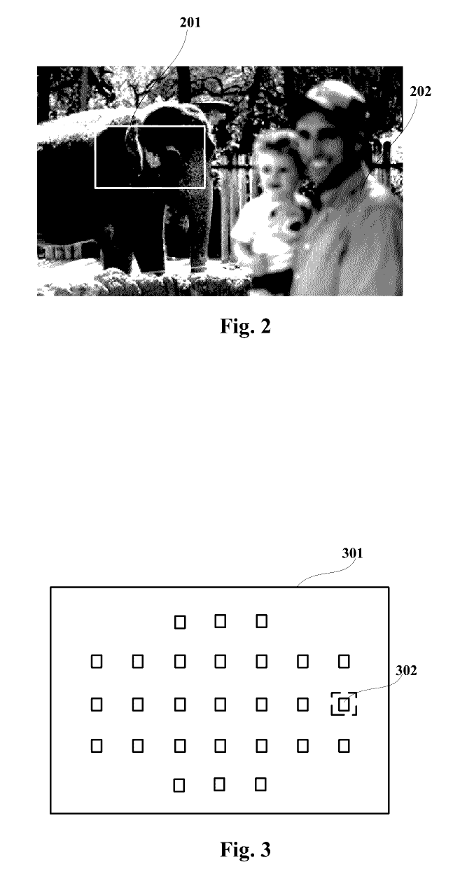

FIG. 2 is a schematic diagram of performing automatic focusing by using the prior art. As shown in FIG. 2, as a focusing point or a focusing zone is automatically selected by the electronic device in the prior art, it is possible that a focusing zone 201 that is not desired by the user is used, and the object 202 that is desired to be shot is dim due to failure in focusing.

FIG. 3 is a schematic diagram of a focusing point of the electronic device of an embodiment of the present disclosure, which shows a case where a view finder 301 has multiple focusing points. As shown in FIG. 3, the electronic device has 27 focusing points, in which one or more (such as a focusing point 302) may be selected for focusing. A selected focusing point may be automatically adjusted according to the position of the object in the present disclosure. A case of the focusing points is shown in FIG. 3, and a case of a focusing zone is similar to this. For simplicity, following description is given taking focusing points as an example only.

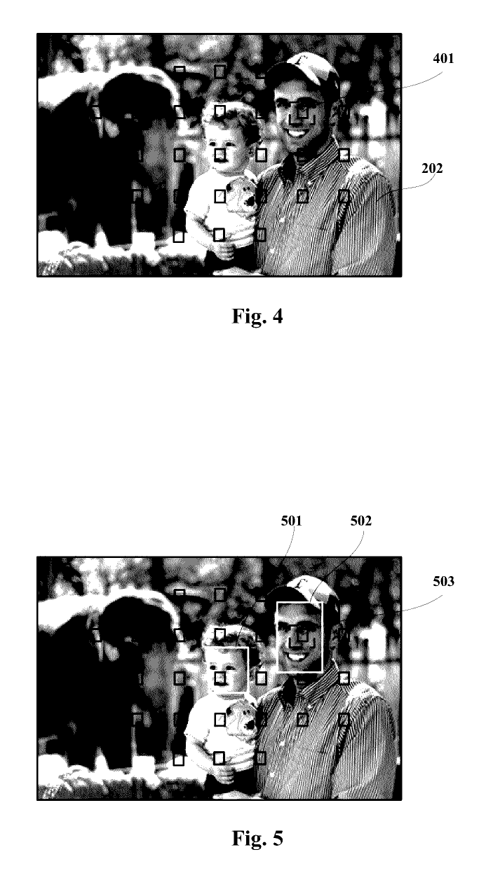

FIG. 4 is a schematic diagram of a viewfinder in forming an image of an embodiment of the present disclosure, which shows a case where a position is determined according to a sound of the object and an adjusted focusing point is used for focusing. As shown in FIG. 4, in preparation of shooting, the object 202 may emit a sound of “cheese”, and after receiving the sound, the electronic device may determine the position of the object according to a direction of the sound. For example, two microphones may be provided at left and right sides of the electronic device, and whether the received sound is from the left or the right is calculated according to a difference between intensities of the sounds received by the two microphones. However, the present disclosure is not limited thereto, and any related manners may be used.

Then the electronic device may automatically adjust a focusing point according to the position of the object. For example, in a case where it is determined that the object is located at the right, a focusing point 503 at the right may be automatically selected from multiple focusing points (such as 27 focusing points), and focusing is performed by a focusing apparatus, forming a case shown in FIG. 5. Thereafter, the shutter may be pressed for shooting, so as to obtain a clear image of the object.

In this embodiment, matching of sounds and/or images may also be performed, and a focusing point or a focusing zone is adjusted when the matching is successful, thereby further improving accuracy of the focusing.

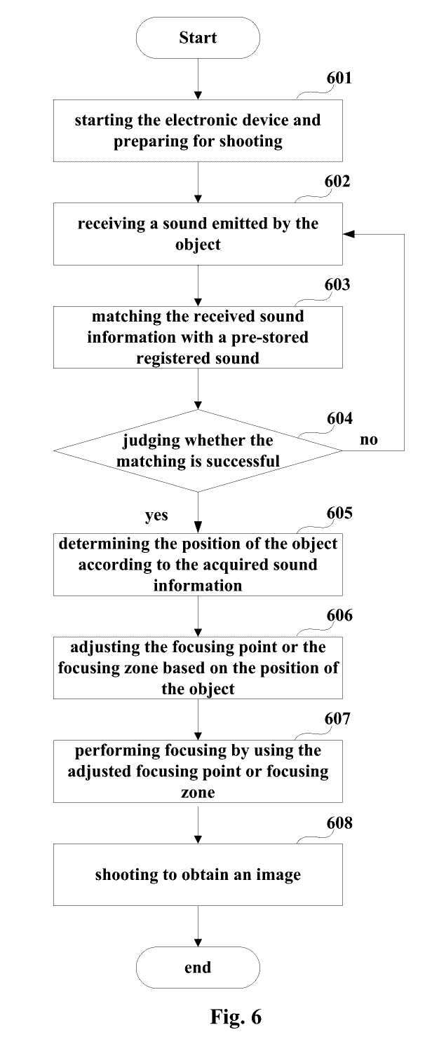

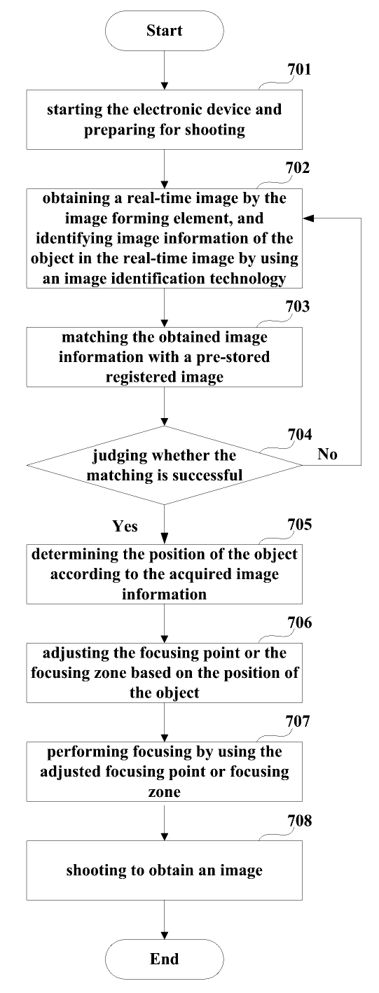

FIG. 6 is another flowchart of the image forming method of the embodiment of the present disclosure. As shown in FIG. 6, the image forming method includes:

Step 601: starting the electronic device and preparing for shooting;

Step 602: receiving a sound emitted by the object;

for example, sound information may be obtained via microphone(s);

Step 603: matching the received sound information with a pre-stored registered sound.

In this embodiment, a specific sound of the object may be recorded in advance, so as to obtain and store the registered sound; for example, a sound of “cheese” emitted by a user Peter may be stored in advance as a registered sound; or the registered sound transmitted by another device may be obtained via a communication interface and stored; for example, the registered sound may be obtained via an email, and social software, etc., or the registered sound may also be obtained via a universal serial bus (USB), Bluetooth, or NFC, etc.; however, the present disclosure is not limited thereto, and any manner of obtaining a registered sound may be employed.

In this embodiment, the sound information includes a sound content and/or a sound characteristic (such as a voice print); and when the sound content and/or sound characteristic in the acquired sound information is/are in consistence with the sound content and/or sound characteristic in the registered sound, it is determined that the sound matching is successful; the relevant art may be used for the matching of the sound information and the registered sound; for example, a sound waveform identification technology may be used for identifying the registered sound and the acquired sound information.

For example, the specific sound of “cheese” of the user Peter may be stored in advance, the sound information including both a sound content “cheese” and a specific voice print of Peter; the sound matching is determined as being successful only when “cheese” emitted by Peter is received, and the position of Peter is determined according to the direction of the sound; and the sound matching is determined as failed when Peter emits other sounds or other users emit sounds.

Furthermore, a threshold value for matching may be set, and the registered sound and the acquired sound information are determined as matched when a similarity of matching exceeds the threshold value; for example, the threshold value may be set as 80%, when the similarity is identified as 82% by using the sound waveform identification technology, the registered sound and the acquired sound information are determined as matched; and when the similarity is identified as 42% by using the sound waveform identification technology, the registered sound and the acquired sound information are determined as unmatched.

Matching of the acquired sound information and the registered sound is illustrated above; however, the present disclosure is not limited thereto, and a particular manner of matching may be determined according to an actual situation.

Step 604: judging whether the matching is successful, and executing Step 605 if the matching is successful; otherwise, turning back to Step 602.

In this embodiment, the focusing point or the focusing zone is adjusted only in a case of successful matching, thereby avoiding outer interference, such as noise, and further improving accuracy of the focusing.

Furthermore, when the acquired sound information is matched with the registered sound, information prompt for matching success may be performed, such as emitting a prompt sound, or flashing an indication lamp, and/or, when the acquired sound information is not matched with the registered sound, information prompt for matching failure may be performed; a particular manner of information prompt is not limited in the present disclosure.

Step 605: determining the position of the object according to the acquired sound information.

For example, a position of a source of sound may be calculated according to a difference between intensities of sounds received by microphones provided at different positions, thereby determining the position of the object.

Step 606: adjusting the focusing point or the focusing zone based on the position of the object;

Step 607: performing focusing by using the adjusted focusing point or focusing zone; and

Step 608: shooting to obtain an image.

The present disclosure is described above by means of the acquired sound information, and the present disclosure shall be described below by means of the acquired image information.

FIG. 7 is a further flowchart of the image forming method of the embodiment of the present disclosure. As shown in FIG. 7, the image forming method includes:

Step 701: starting the electronic device and preparing for shooting;

Step 702: obtaining a real-time image by the image forming element, and identifying image information of the object in the real-time image by using an image identification technology.

For example, the face of the object is identified by using a face identification technology.

Step 703: matching the obtained image information with a pre-stored registered image.

In this embodiment, the object may be shot in advance so as to obtain and store the registered image; for example, the face of the user Peter may be stored in advance as a registered image; or the registered image transmitted by another device may be obtained via a communication interface and stored; for example, the registered image may be obtained via an email, and social software, etc., or the registered image may also be obtained via a USB, Bluetooth, or NFC, etc.; however, the present disclosure is not limited thereto, and any manner of obtaining a registered image may be employed.

In this embodiment, the image information may include person information and/or scene information, the person information including one of the following information or a combination thereof: a face of a person, a body gesture, and a hand gesture identity, and the scene information including one of the following information or a combination thereof: a designated object, a building, a natural scene, and an artificial ornament; and the registered image may include person information and/or scene information; such as those described above; however, the present disclosure is not limited thereto, and any other images may be used.

In this embodiment, the registered image may also be obtained from the network in a real-time manner, such as being obtained on line via social software (Facebook, and Instagram, etc.); for example, when Peter is travelling in California of the United States, the portable electronic device may obtain a current position via a positioning apparatus (such as GPS), and obtain that the Golden Gate Bridge is located at the current position via third-party software; the electronic device may obtain an image of the Golden Gate Bridge on line and take it as a registered image; and when Peter uses the electronic device to align with the Golden Gate Bridge for shooting, the electronic device may automatically match with the registered image, and adjust a focusing point or a focusing zone, thereby automatically obtaining an image of the Golden Gate Bridge which is clearly aligned.

In this embodiment, for the convenience of explanation, description shall be given below taking that the registered image contains a face of a person and/or a hand gesture identity as an example.

In this embodiment, matching of the image information and the registered image may be performed by using the prior art; for example, a face identification technology may be used to identify a face of a person in the registered image and a face of a person in the real-time image, such as performing mode identification according to facial features of the face, so as to judge whether the face of a person in the registered image is the same as the face of a person in the real-time image; and in a case where the faces are the face of the same person, it is determined that the face of a person in the registered image and the face of a person in the real-time image are matched.

Alternatively, an image identification technology may be used to identify a hand gesture identity in the registered image and a hand gesture identity in the real-time image, such as performing mode identification according to a V-shaped gesture shown by the user, so as to judge whether the V-shaped gesture in the registered image and the V-shaped gesture in the real-time image are the same identity; and in a case where the identities are the same, it is determined that the hand gesture identity in the registered image and the hand gesture identity in the real-time image are matched.

Furthermore, a threshold value for matching may be set, and the object in the registered image and the object in the real-time image are determined as matched when a similarity of matching exceeds the threshold value; for example, the threshold value may be set as 80%, when the similarity of faces of persons in the registered image and the real-time image is identified as 82% by using the face identification technology, the object in the registered image and the object in the real-time image are determined as matched; and when the similarity of faces of persons in the registered image and the real-time image is identified as 42% by using the face identification technology, the object in the registered image and the object in the real-time image are determined as unmatched.

Matching of the real-time image and the registered image is illustrated above; however, the present disclosure is not limited thereto, and a particular manner of matching may be determined according to an actual situation.

Step 704: judging whether the matching is successful, and executing Step 705 if the matching is successful; otherwise, turning back to Step 702.

In this embodiment, the focusing point or the focusing zone is adjusted only in a case of successful matching, thereby avoiding outer interference, such as noise, and further improving accuracy of the focusing.

Furthermore, when the acquired image information is matched with the registered image, information prompt for matching success may be performed, such as emitting a prompt sound, or flashing an indication lamp, and/or, when the acquired image information is not matched with the registered image, information prompt for matching failure may be performed; a particular manner of information prompt is not limited in the present disclosure.

Step 705: determining the position of the object according to the acquired image information.

For example, the position of the object may be determined according to the position of the identified image information in the whole real-time image.

Step 706: adjusting the focusing point or the focusing zone based on the position of the object;

Step 707: performing focusing by using the adjusted focusing point or focusing zone; and

Step 708: shooting to obtain an image.

The present disclosure is described above by means of the sound information and the image information; furthermore, the sound information and the image information may be combined, so as to determine the position of the object and adjust the focusing point or the focusing zone, thereby performing the focusing more accurately.

In this embodiment, after the image shooting, the image formed by shooting may be processed. For example, the shot image may be cropped, removing the parts around the shot image and placing the object at the middle of the image; or further sharpening a part of the object; or adjusting the whole or part of the shot image with respect to brightness, saturation, and white balance, etc. However, the present disclosure is not limited thereto, and particular image processing may be determined according to an actual situation.

It should be noted that the present disclosure is described above taking a static image (picture) as an example only. However, the image forming method of the embodiment of the present disclosure is not only applicable to shooting a static image, such as a photo, but also to a dynamic image, such as a video image.

It can be seen from the above embodiment that the position of the object is determined according to the acquired sound information and/or image information, and the focusing point or focusing zone is adjusted based on the position of the object, thereby performing focusing accurately, obtaining an effect of highlighting the object, and forming an image of higher quality.

### Embodiment 2

An embodiment of the present disclosure provides an image forming apparatus, corresponding to the image forming method described in Embodiment 1, with the identical content being understood as included below but not going to be re-described any further to avoid being repetitive.

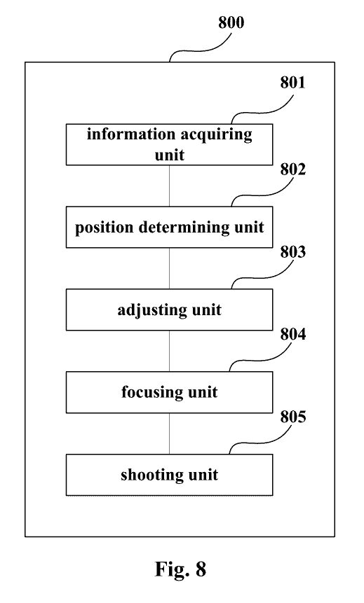

FIG. 8 is a schematic diagram of the structure of the image forming apparatus of Embodiment 2 of the present disclosure. As shown in FIG. 8, the image forming apparatus 800 includes:

an information acquiring unit 801, configured to acquire sound information emitted by an object and/or image information of the object;

a position determining unit 802, configured to determine a position of the object according to the acquired sound information and/or image information;

an adjusting unit 803, configured to adjust a focusing point or a focusing zone based on the position of the object;

a focusing unit 804, configured to use the adjusted focusing point or focusing zone for focusing; and

a shooting unit 805, configured to shoot to obtain an image.

In this embodiment, the image forming apparatus 800 may be a hardware apparatus, and may also be a software module controlled by a central processing unit in the electronic device to carry out said image forming method. However, the present disclosure is not limited thereto, and a particular implementation may be determined according to an actual situation.

In this embodiment, the adjusting unit 803 may select one or more focusing points to which the position of the object corresponds from multiple focusing points based on the position of the object, or select a part of the focusing zone to which the position of the object corresponds from the whole focusing zone based on the position of the object.

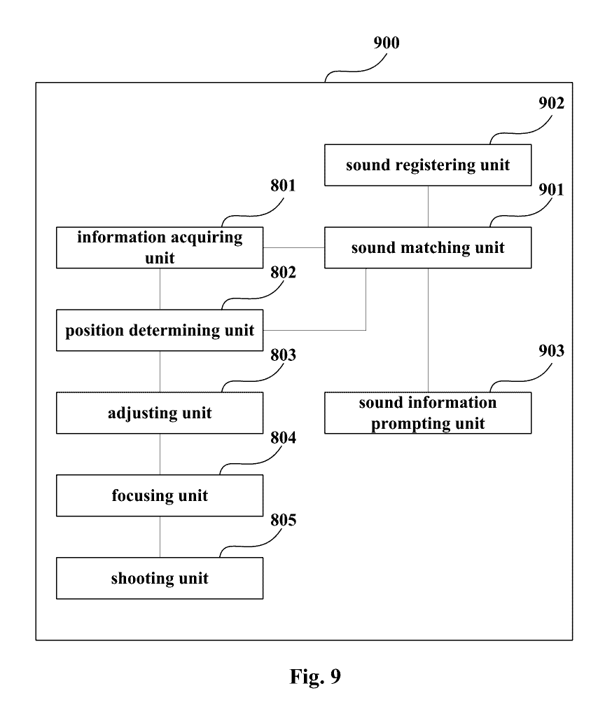

FIG. 9 is another schematic diagram of the structure of the image forming apparatus of the embodiment of the present disclosure. As shown in FIG. 9, the image forming apparatus 900 includes: an information acquiring unit 801, a position determining unit 802, an adjusting unit 803, a focusing unit 804 and a shooting unit 805, as described above.

As shown in FIG. 9, the image forming apparatus 900 may further include:

a sound matching unit 901, configured to match the acquired sound information with a pre-stored registered sound; and the position determining unit 802 is further configured to determine the position of the object according to the acquired sound information if the matching is successful.

As shown in FIG. 9, the image forming apparatus 900 may further include:

a sound registering unit 902, configured to record a sound of the object so as to obtain the registered sound, or obtain via a communication interface the registered sound transmitted by another device.

As shown in FIG. 9, the image forming apparatus 900 may further include:

a sound information prompting unit 903, configured to perform information prompt for matching success when the acquired sound information is matched with the registered sound, and/or perform information prompt for matching failure when the acquired sound information is not matched with the registered sound.

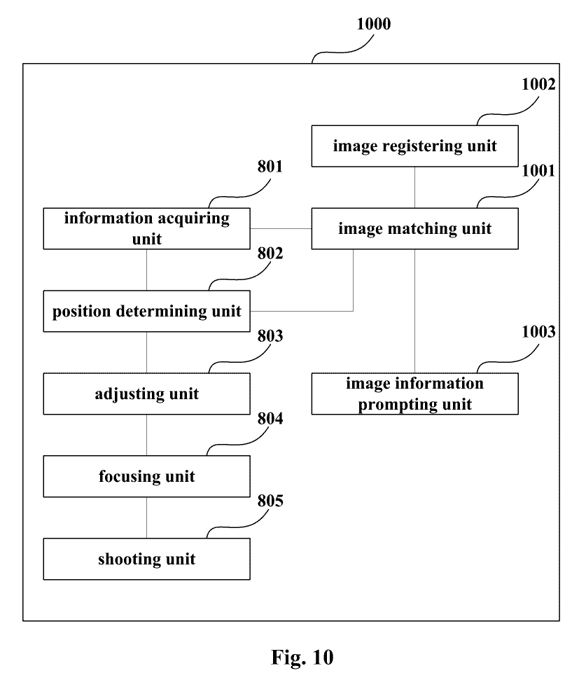

FIG. 10 is a further schematic diagram of the structure of the image forming apparatus of the embodiment of the present disclosure. As shown in FIG. 10, the image forming apparatus 1000 includes: an information acquiring unit 801, a position determining unit 802, an adjusting unit 803, a focusing unit 804 and a shooting unit 805, as described above.

As shown in FIG. 10, the image forming apparatus 1000 may further include:

an image matching unit 1001, configured to match the acquired image information with a pre-stored registered image; and the position determining unit 802 is further configured to determine the position of the object according to the acquired image information if the matching is successful.

As shown in FIG. 10, the image forming apparatus 1000 may further include:

an image registering unit 1002, configured to shoot the object so as to obtain the registered image, or obtain via a communication interface the registered image transmitted by another device.

As shown in FIG. 10, the image forming apparatus 1000 may further include:

an image information prompting unit 1003, configured to perform information prompt for matching success when the acquired image information is matched with the registered image, and/or perform information prompt for matching failure when the acquired image information is not matched with the registered image.

It can be seen from the above embodiment that the position of the object is determined according to the acquired sound information and/or image information, and the focusing point or focusing zone is adjusted based on the position of the object, thereby performing focusing accurately, obtaining an effect of highlighting the object, and forming an image of higher quality.

### Embodiment 3

An embodiment of the present disclosure provides an electronic device, which controls an image forming element (such as a camera, and a lens, etc.), and may be a mobile phone, a camera, a video camera, and a tablet personal computer, etc., and this embodiment is not limited thereto.

In this embodiment, the electronic device may include an image forming element, a focusing apparatus, and the image forming apparatus described in Embodiment 2, the contents of which being incorporated herein, with the repeated parts being not going to be described any further.

The focusing apparatus may include: a voice coil motor (VCM), including but not limited to a smart VCM, a conventional VCM, VCM2, VCM3; a T-lens; a piezo motor drive, a smooth impact drive mechanism (SIDM); and a liquid actuator, etc., or other forms of focusing motors.

In this embodiment, the electronic device may be a mobile terminal; however, the present disclosure is not limited thereto.

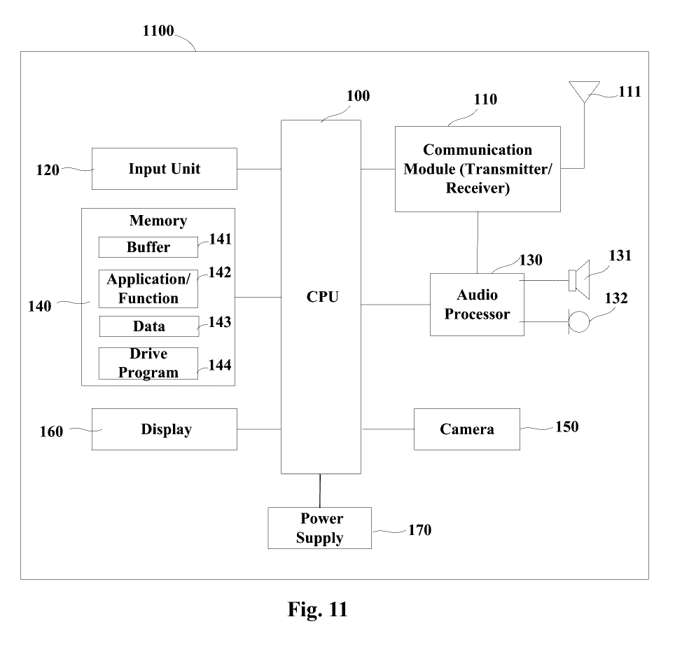

FIG. 11 is a schematic diagram of the systematic structure of the electronic device of the embodiment of the present disclosure. The electronic device 1100 may include a central processing unit 100 and a memory 140, the memory 140 being coupled to the central processing unit 100. It should be noted that such a figure is exemplary only, and other types of structures may be used to supplement or replace this structure for the realization of telecommunications functions or other functions.

In an implementation, functions of the image forming apparatus 800 may be integrated into the central processing unit 100. Wherein, the central processing unit 100 may be configured to: control to carry out the image forming method described in Embodiment 1.

In another implementation, the image forming apparatus 800 and the central processing unit 100 may be configured separately. For example, the image forming apparatus 800 may be configured as a chip connected to the central processing unit 100, with the functions of the image forming apparatus 800 being realized under control of the central processing unit.

As shown in FIG. 11, the electronic device 1100 may further include a communication module 110, an input unit 120, an audio processing unit 130, a camera 150, a display 160, and a power supply 170.

The central processing unit 100 (which is sometimes referred to as a controller or control, and may include a microprocessor or other processor devices and/or logic devices) receives input and controls each part and operation of the electronic device 1100. The input unit 120 provides input to the central processing unit 100. The input unit 120 may be for example a key or touch input device. The camera 150 is used to take image data and provide the taken image data to the central processing unit 100 for use in a conventional manner, for example, for storage, and transmission, etc.

The power supply 170 is used to supply power to the electronic device 1100. And the display 160 is used to display the objects of display, such as images, and characters, etc. The display may be for example an LCD display, but it is not limited thereto.

The memory 140 may be a solid memory, such as a read-only memory (ROM), a random access memory (RAM), and a SIM card, etc., and may also be such a memory that stores information when the power is interrupted, may be optionally erased and provided with more data. Examples of such a memory are sometimes referred to as an EPROM, etc. The memory 140 may also be certain other types of devices. The memory 140 includes a buffer memory 141 (sometimes referred to as a buffer). The memory 140 may include an application/function storing portion 142 used to store application programs and function programs, or to execute the flow of the operation of the electronic device 1100 via the central processing unit 100.

The memory 140 may further include a data storing portion 143 used to store data, such as a contact person, digital data, pictures, voices and/or any other data used by the electronic device. A driver storing portion 144 of the memory 140 may include various types of drivers of the electronic device for the communication function and/or for executing other functions (such as application of message transmission, and application of directory, etc.) of the electronic device.

The communication module 110 is a transmitter/receiver 110 transmitting and receiving signals via an antenna 111. The communication module (transmitter/receiver) 110 is coupled to the central processing unit 100 to provide input signals and receive output signals, this being similar to the case in a conventional mobile phone.

A plurality of communication modules 110 may be provided in the same electronic device for various communication technologies, such a cellular network module, a Bluetooth module, and/or wireless local network module, etc. The communication module (transmitter/receiver) 110 is also coupled to a loudspeaker 131 and a microphone 132 via the audio processing unit 130, for providing audio output via the loudspeaker 131 and receiving audio input from the microphone 132, thereby realizing normal telecommunications functions. The audio processing unit 130 may further include any suitable buffer, decoder, and amplifier, etc. Furthermore, the audio processing unit 130 is coupled to the central processing unit 100, such that sound recording may be performed in the local machine via the microphone 132, and the sounds stored in the local machine may be played via the loudspeaker 131.

An embodiment of the present disclosure further provides a computer-readable program, wherein when the program is executed in an electronic device, the program enables the computer to carry out the image forming method as described in Embodiment 1 in the electronic device.

An embodiment of the present disclosure further provides a storage medium in which a computer-readable program is stored, wherein the computer-readable program enables the computer to carry out the image forming method as described in Embodiment 1 in an electronic device.

The preferred embodiments of the present disclosure are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present disclosure may be implemented by hardware, software, firmware, or a combination thereof In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present disclosure by using the devices.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. An image forming method, comprising:
acquiring sound information emitted by an object and/or image information of the object;
determining a position of the object according to the acquired sound information and/or image information;
adjusting a focusing point or a focusing zone based on the position of the object;
using the adjusted focusing point or focusing zone for focusing; and
shooting to obtain an image.

2. The image forming method according to claim 1, wherein before shooting to obtain an image, the method further comprises:
matching the acquired sound information with a pre-stored registered sound; and
determining the position of the object according to the acquired sound information if the matching is successful.

3. The image forming method according to claim 2, wherein the sound information comprises a sound content and/or a sound characteristic;
and the sound matching is determined as being successful when the sound content and/or the sound characteristic in the acquired sound information is/are in consistence with a sound content and/or a sound characteristic in the registered sound.

4. The image forming method according to claim 1, wherein before shooting to obtain an image, the method further comprises:
matching the acquired image information with a pre-stored registered image; and
determining the position of the object according to the acquired image information if the matching is successful.

5. The image forming method according to claim 4, wherein the image information comprises person information and/or scene information, and the registered image comprises person information and/or scene information.

6. The image forming method according to claim 5, wherein the person information comprises one of the following information or a combination thereof: a face of a person, a body gesture, and a hand gesture identity; and the scene information comprises one of the following information or a combination thereof: a designated object, a building, a natural scene, and an artificial ornament.

7. The image forming method according to claim 1, wherein the adjusting a focusing point or a focusing zone based on the position of the object comprises:
selecting one or more focusing points to which the position of the object corresponds from multiple focusing points based on the position of the object, or selecting a part of the focusing zone to which the position of the object corresponds from the whole focusing zone based on the position of the object.

8. The image forming method according to claim 2, wherein the image forming method further comprises:
recording a sound of the object so as to obtain the registered sound, or obtaining via a communication interface the registered sound transmitted by another device.

9. The image forming method according to claim 2, wherein the image forming method further comprises:
performing information prompt for matching success when the acquired sound information is matched with the registered sound, and/or performing information prompt for matching failure when the acquired sound information is not matched with the registered sound.

10. The image forming method according to claim 4, wherein the image forming method further comprises:
shooting the object so as to obtain the registered image, or obtaining via a communication interface the registered image transmitted by another device.

11. The image forming method according to claim 4, wherein the image forming method further comprises:
performing information prompt for matching success when the acquired image information is matched with the registered image, and/or performing information prompt for matching failure when the acquired image information is not matched with the registered image.

12. An image forming apparatus, comprising:
an information acquiring unit configured to acquire sound information emitted by an object and/or image information of the object;
a position determining unit configured to determine a position of the object according to the acquired sound information and/or image information;
an adjusting unit configured to adjust a focusing point or a focusing zone based on the position of the object;
a focusing unit configured to use the adjusted focusing point or focusing zone for focusing; and
a shooting unit configured to shoot to obtain an image.

13. The image forming apparatus according to claim 12, wherein the image forming apparatus further comprises:
a sound matching unit configured to match the acquired sound information with a pre-stored registered sound;
and the position determining unit is further configured to determine the position of the object according to the acquired sound information if the matching is successful.

14. The image forming apparatus according to claim 12, wherein the image forming apparatus further comprises:
an image matching unit configured to match the acquired image information with a pre-stored registered image;
and the position determining unit is further configured to determine the position of the object according to the acquired image information if the matching is successful.

15. The image forming apparatus according to claim 12, wherein the adjusting unit selects one or more focusing points to which the position of the object corresponds from multiple focusing points based on the position of the object, or selects a part of the focusing zone to which the position of the object corresponds from the whole focusing zone based on the position of the object.

16. The image forming apparatus according to claim 13, wherein the image forming apparatus further comprises:
a sound registering unit configured to record a sound of the object so as to obtain a registered sound, or obtain via a communication interface a registered sound transmitted by another device.

17. The image forming apparatus according to claim 13, wherein the image forming apparatus further comprises:
a sound information prompting unit configured to perform information prompt for matching success when the acquired sound information is matched with a registered sound, and/or perform information prompt for matching failure when the acquired sound information is not matched with the registered sound.

18. The image forming apparatus according to claim 14, wherein the image forming apparatus further comprises:
an image registering unit configured to shoot the object so as to obtain the registered image, or obtain via a communication interface the registered image transmitted by another device.

19. The image forming apparatus according to claim 14, wherein the image forming apparatus further comprises:
an image information prompting unit configured to perform information prompt for matching success when the acquired image information is matched with a registered image, and/or perform information prompt for matching failure when the acquired image information is not matched with the registered image.

20. An electronic device, having an image forming element and a focusing apparatus and comprising:
the image forming apparatus as claimed in claim 12.
